(19) United States
(12) Patent Application Publication
(10) Pub. No.: US 2003/0078812 A1
(43) Pub. Date: Apr. 24, 2003

(54) Medical information system for improving efficiency of clinical record creating operations

(75) Inventor: Akinobu Uchikubo, Iruma-shi (JP)

Correspondence Address: Scully, Scott, Murphy & Presser, 400 Garden City Plaza, Garden City, NY, 11530, US

(73) Assignee: OLYMPUS OPTICAL CO., LTD., TOKYO (JP)

(21) Appl. No.: 10/230,487

(22) Filed: Aug. 29, 2002

(30) Foreign Application Priority Data
Aug. 30, 2001 (JP) 2001-262351
Aug. 30, 2001 (JP) 2001-262352

(51) Int. Cl. G06F 17/60

(52) U.S. Cl. 705/3

(57) ABSTRACT

In a medical information system, individual information such as endoscope image information acquired from an endoscope device, surgery device information acquired from a surgery device, and patient information acquired from an input device, is accumulated and edited in a first controller. Thus, medical treatment information generated at different input devices, or in different situations, is automatically accumulated in the first controller of the medical information system, so the time for collecting and accumulating medical treatment information is reduced, thereby making clinical record creating operations efficient.

This application claims benefit of Japanese Application No. 2001-262351 filed in Japan on Aug. 30, 2001, and Japanese Application No. 2001-262352 filed in Japan on Aug. 30, 2001, the contents of which are incorporated by this reference.

### BACKGROUND OF THE INVENTION

1. Field of the Invention

The present invention relates to a medical information system having functions for generating clinical records where medical treatment information is recorded.

2. Description of the Related Art

In recent years, medical information processing apparatuses, which enable users to generate clinical records electronically by inputting information such as medical treatment information for patients, endoscope image data obtained through endoscope devices, and so forth, have come to be used in medical institutions, or the like.

For example, Japanese Unexamined Patent Application Publication No. 2000-33072 describes means for generating clinical records by operators inputting medical treatment information in a screen, acquiring endoscope image data from an endoscope device, or editing input information, at each step, following operation guides displayed on the screen.

However, with conventional techniques, for example, such as indicated in Japanese Unexamined Patent Application Publication No. 2000-33072, the troublesome operations of inputting medical treatment information of a patient in the screen, or the troublesome operations of acquiring endoscope images occurs every time, and since means for acquiring surgical device information such as operation information in the event that an operator operates a surgical device other than an endoscope, such as an electrocauterizer device, a gas insufflator, an ultrasonic surgical device, or the like, and measurement information and so forth obtained by these surgical devices, are not described therein, the trouble for inputting these medical device information in the screen occurs, and time is required for the work for collecting and accumulating various types of medical treatment information, so a great deal of time is spent on daily clinical record creating operations.

### SUMMARY OF THE INVENTION

It is an object of the present invention to provide a medical information system for improving the efficiency of clinical record creating operations by cutting down on the time for collecting and accumulating medical treatment information.

A medical information system according to the present invention comprises a server for registering patient identification information for identifying a patient, and accumulating personal information of the patient, and a controller which is connected to a plurality of medical devices for surgery, for communicating with the above server, and for creating clinical record information based upon medical information from the plurality of medical devices and the above personal information from the above server.

Other features and advantages of the present invention will become fully clear by the following description.

### BRIEF DESCRIPTION OF THE DRAWINGS

FIGS. 1 through 4 relate to an embodiment of the present invention, wherein;

FIG. 1 is an explanatory diagram which illustrates the overall configuration of the medical information processing system;

FIG. 2 is a block diagram which illustrates the structure of a first controller shown in FIG. 1;

FIG. 3 is an explanatory diagram which illustrates a display example of a summarized information screen displayed on a display device shown in FIG. 1; and

FIG. 4 is an explanatory diagram which illustrates the principal component configuration of a modification of the medical information processing system.

### DETAILED DESCRIPTION OF THE PREFERRED EMBODIMENTS

Embodiments of the present invention will be described below with reference to the drawings.

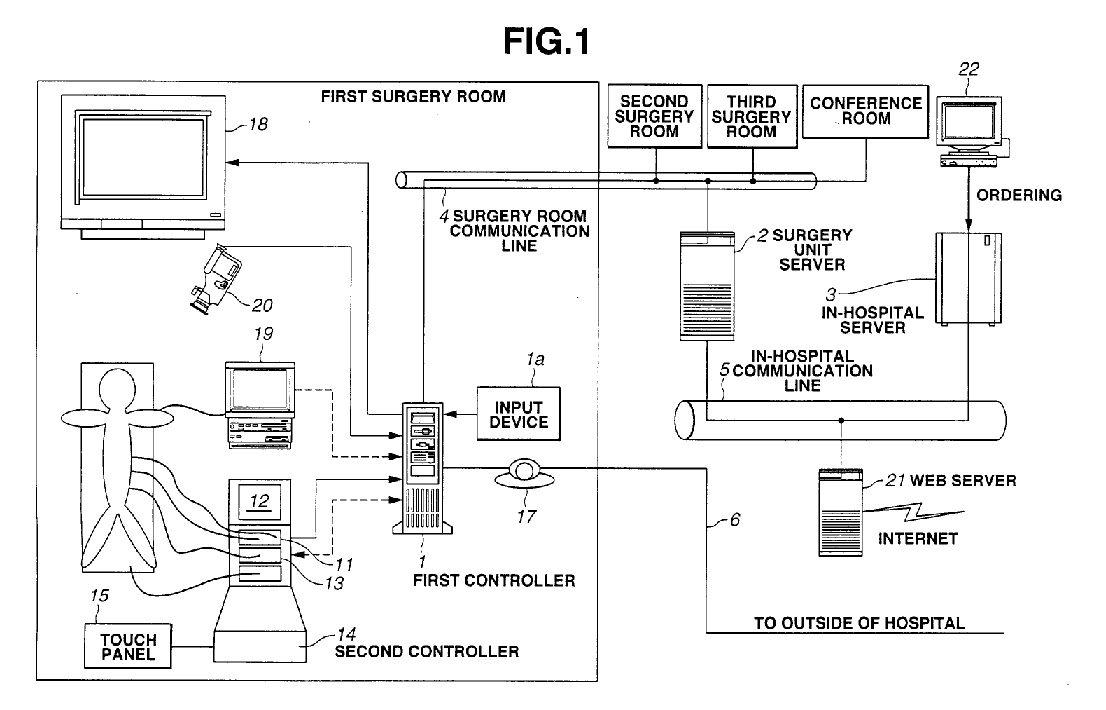

As shown in FIG. 1, the medical information processing system employed in the present embodiment comprises a first controller 1 which is installed in a base such as a surgery room or the like and acquires various types of medical information generated in the surgery room or the like, a surgery unit server 2 which is installed at a remote location from the above surgical room and accumulates the various types of medical treatment information acquired by the above first controller 1 and creates clinical records, and an in-hospital server 3 which is installed in a different base from the above surgery unit server 2 and makes reference to the clinical record information obtained by the above surgery unit server 2, wherein the above first controller 1 and the above surgery unit server 2, and the above surgery unit server 2 and the above in-hospital server 3, are connected by communication lines 4 and 5, respectively. Note that the foregoing communication lines 4 and 5 may be any communication line, such as a public line, private line, LAN (local area network), or the like. Also, the foregoing in-hospital server 3 may be installed in the same base as the foregoing surgery unit server 2.

It should be noted that the information transmitted from the first controller 1 to the surgery unit server 2 is described, for example, in the XML (extensible Markup Language) format.

A second controller 14 comprises an endoscope device 11 for taking images of a subject such as within the body cavity of a patient and for acquiring picture signals including endoscope images, a display device 12 for displaying the picture signals acquired by the endoscope device 11, and a surgical device 13 such as an electrocauterizer device, gas insufflator, ultrasonic surgical device, or the like, wherein the second controller 14 controls the above surgical device 13, and acquires surgical device information such as measurement information and so forth from the above surgical device 13.

The second controller 14 is connected to a surgical device control input means such as a touch panel 15 for inputting control instructions and so forth for the above surgical device 13 to the above second controller 14.

The surgical device information provided from the above second controller 14 and the patient information obtained from an organism monitoring device 19 is accumulated in the first controller 1 via the communication line, and is transmitted to the surgery unit server 2 situated at a different base via the communication line 4.

Also, the picture signals acquired from the above endoscope device 11 and the picture signals obtained by an in-room camera 20 for taking images of the scene of the surgery room are input to a signal transmission device 17 via the first controller 1, and are transmitted externally via a communication line 6.

Also, a display device 18 or the like for displaying surgical device information acquired by the first controller 1, patient information obtained from the surgery unit server 2, and information received by the above signal transmission device 17 from the different base, is arranged in the surgery room.

The surgery unit server 2 is connected to the in-hospital server 3 and a Web server 21 via the communication line 5. Note that the above Web server 21 is also connected externally from the hospital via the Internet.

The in-hospital server 3 accumulates patient registration information from the patient registration terminal 22 in the hospital, pre-surgery images corresponding to the patient, and medical images such as in-surgery images (MR, CT, x-ray images and so forth). The surgery unit server 2 reads out the registration information such as the name, the date of birth, and diagnosis records of the patient having surgery, and the medical images corresponding to the patient, via the communication line 5 from the in-hospital server 3.

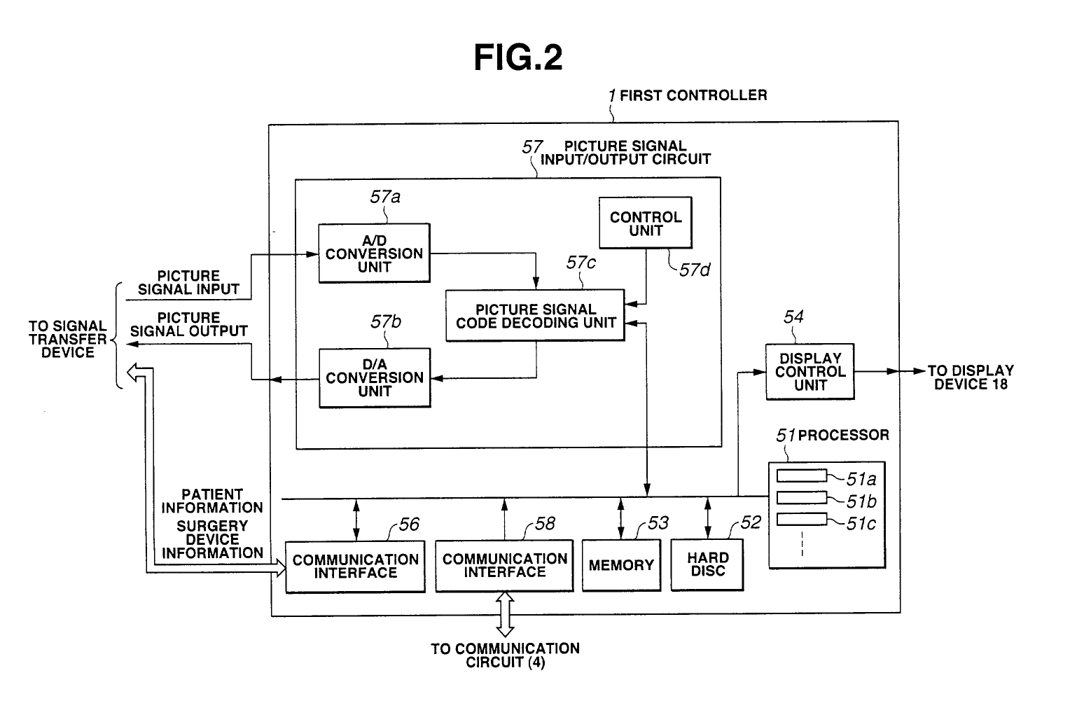

As shown in FIG. 2, the first controller 1 comprises: a processor 51 which controls each unit of the first controller 1; a hard disk 52 and memory 53 for storing software which the processor 51 executes and data such as the above endoscope images and the above patient information, and for securing work area for the processor 51; a display control unit 54 for creating picture signals for driving the above display unit 18; a communication interface 56 for transmitting organism information, surgery device information, and so forth with the organism monitoring device 19 and the second controller 14; a picture signal input/output circuit 57 which inputs and outputs picture signal information including endoscope images to and from the above signal transmission device 17; and a communication interface 58 for transmitting information via the above communication line 4.

The foregoing processor 51 includes an information accumulation unit 51a for accumulating software stored in the hard disk 52 and the memory 53, as well as patient information, surgery device information, and so forth input individually via the above communication interfaces 56 and 58, a display information creation unit 51b for editing the information accumulated by the information accumulation unit 51a, and creating screen information displayed on the display device 18, a clinical record creating unit 51c for editing the accumulated information and creating output clinical records, and so forth.

The foregoing picture signal input/output circuit 57 comprises an A/D conversion unit 57a for converting input analog picture signals into digital picture signals, a D/A conversion unit 57b for converting digital picture signals into analog picture signals and outputting the analog signals, a picture signal code decoding unit 57c having functions for decoding the picture signals input via the A/D conversion unit 57a, extracting desired endoscope picture signals from those input picture signals and encoding output picture signals which are provided to the D/A conversion unit 57b, and a control unit 57d for controlling each unit of the picture signal input/output circuit 57, such as the picture signal code decoding unit 57c.

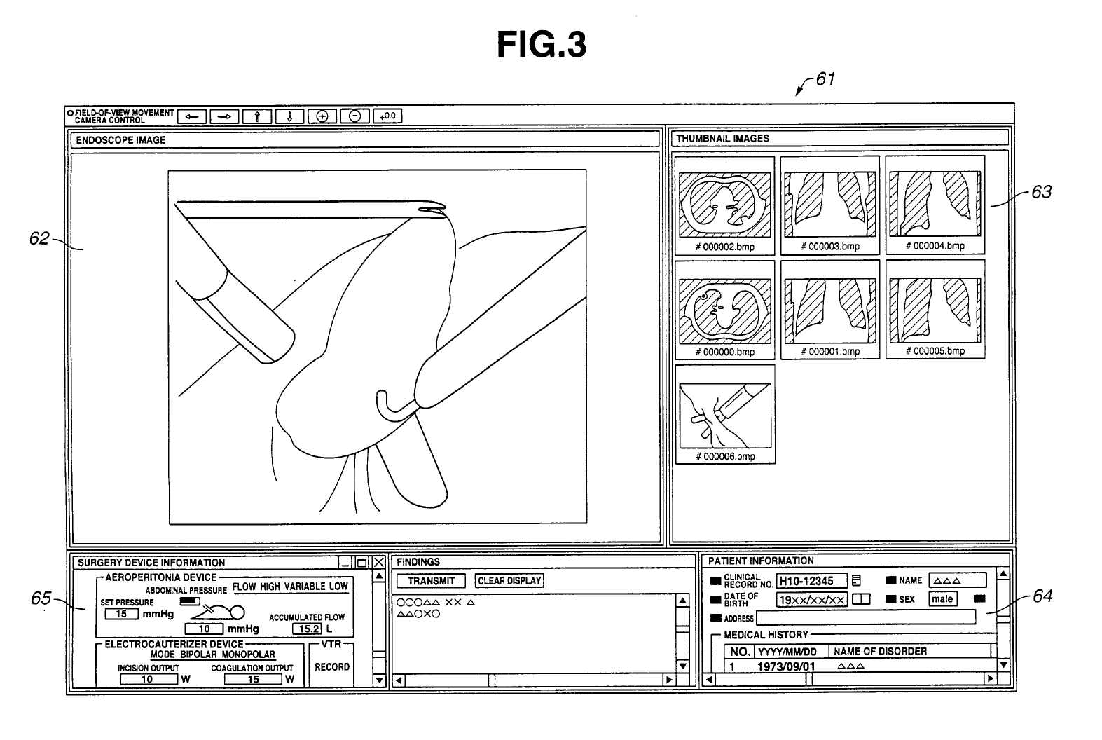

Also, as shown in FIG. 3, arranged on a summarized information screen 61 displayed on the above display device 18 by the output from the first controller 1 are; an endoscope image area 62 for displaying endoscope images, a thumbnail image area 63 for displaying a plurality of thumbnail images reduced by thinning out the pixels of the endoscope image, or the like, a patient information area 64 for displaying patient information, a surgery device information area 65 for displaying surgery device information, and so forth.

The first controller 1 is connected to an input device 1a. The input device 1a may be a keyboard, magnetic card reader, optical card reader, IC card reader, bar code reader, or the like, which is used to input a clinical record number (or ID number) and a name in the patient information area 64 shown in FIG. 3. Note that the input device 1a may be connected to the second controller 14. In the event that the input device 1a is connected to the second controller 14, the patient information is transmitted from the second controller 14 to the first controller 1.

The operations of the medical information processing system as configured above will now be described.

The picture signals including endoscope images obtained by the endoscope device 11 at the time of endoscope examination are converted into digital signals by the A/D conversion unit 57a of the picture signal input/output circuit 57 provided in the first controller 1, and are decoded by the picture signal code decoding unit 57c. At that time, as necessary, the picture signal code decoding unit 57c extracts desired endoscope images included in the picture signals under the control of the control unit 57d controlled by the processor 51.

The endoscope image data acquired by the picture signal input/output circuit 57 is accumulated in the information accumulation unit 51a.

On the other hand, the surgery device information obtained by the second controller 14 from the touch panel 15 and the surgery device 13, and patient information obtained from the living body monitoring device 19, is accumulated in the information accumulation unit 51a provided in the first controller 1 via the communication line. Also, on the other hand, the patient information input from the input device 1a is accumulated in the information accumulation unit 51a provided in the first controller 1.

As described above, the information such as endoscope image information, surgery device information, and patient information, which is input from a different device or generated in a different situation, respectively, is accumulated in the information accumulation unit 51a provided in the first controller 1.

The information accumulated by the above information accumulation unit 51a is edited by the display information creating unit 51b for screen display, and the summarized information screen 61 is displayed on the display device 18 (see FIG. 3). Displayed in a summarized manner on the summarized information screen 61 is information such as endoscope image information, patient information, surgery device information, and so forth, which is input from individual input devices, or is generated in individual situations.

That is to say, the first controller 1 reads out the diagnosis records and pre-surgery images (MR, CT, x-ray images, and so forth) of the patient accumulated in the in-hospital server 3 via the surgery unit server 2 based upon the patient information input from the input device 1a, and displays correlated information in the thumbnail image area 63 and the patient information area 64 on the summarized information screen 61 displayed on the display device 18.

An arrangement may be made wherein, in the event that one of the thumbnail images is selected from among the thumbnail images of the endoscope images displayed on the thumbnail image area 63 on the summarized information screen 61, the endoscope image corresponding to the selected thumbnail image is displayed on the endoscope image area 62.

Also, the information accumulated by the above information accumulation unit 51a is edited by the clinical record creating unit 51c which creates clinical records.

As described above, according to the present embodiment, the medical treatment information such as endoscope images, surgery device information, and patient information is accumulated in the first controller 1, which edits the summarized information screen 61 including the clinical records which summarize accumulated information, and displays these on the display device 18, therefore, the time for collecting and accumulating medical treatment information is reduced, and thus, the effect of improving efficiency of the clinical record creating operations can be obtained.

Also, the first controller 1 is capable of accumulating not only the endoscope image information acquired by the endoscope device 11 but also the information of a greater variety of related devices, such as various surgery devices 13.

Also, the first controller 1 integrates the patient information and pre-surgery images obtained from the in-hospital server 3 via the surgery unit server 2, endoscope images acquired during surgery, and recorded information on the surgery device used in surgery, into a single electronic file, which is transmitted to the surgery unit server 2. The in-hospital server 3 reads out the above integrated electronic file of the surgery record from the surgery unit server 2, and places the above information into the electronic clinical records which deal with every aspect of medical examination, diagnosis, treatment, etc. which the patient undergoes at the hospital.

Also, the patient information and pre-surgery images accumulated in an external hospital can be read out from the Web server 21, and can be referred to with the above surgery unit server 2, as well as those accumulated in the above in-hospital server 3.

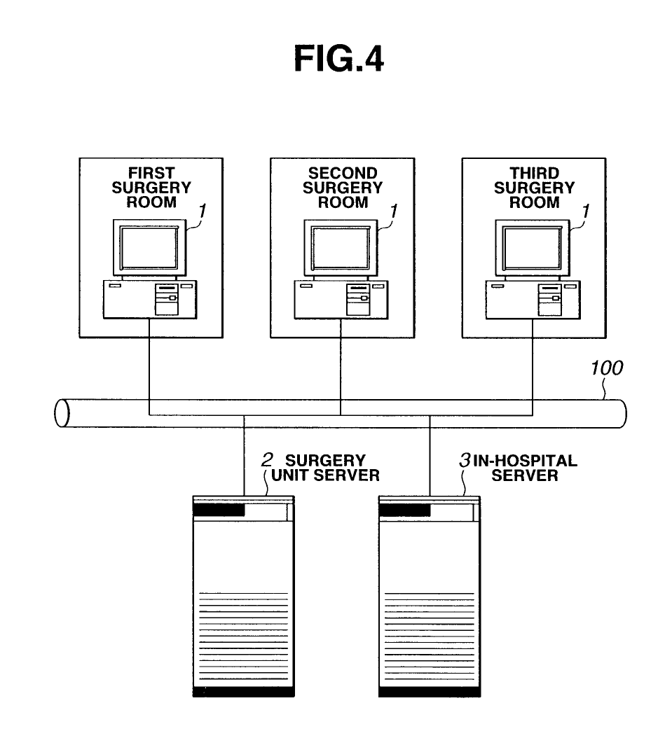

Also, as shown in FIG. 4, an arrangement may be made wherein the in-hospital server 3, the surgery unit server 2, and each first controller 1 (which is installed in each surgery room) are connected to the same network line 100, and in this case, a unique IP address is set for each first controller 1 in each surgery room, and each IP address of each first controller 1 for giving permission for access, is registered in the in-hospital server 3 and the surgery unit server 2 beforehand. Thus, controllers capable of accessing the server are determined beforehand.

The first controller 1 having permission for connection reads out the ID code of the patient from the in-hospital server 3, the diagnosis records, and so forth, correlates the operation information of the endoscope device in the surgery room with the organism information of the patient, which is stored in the surgery unit server 2.

In the present embodiment, while the IP addresses are used for the in-hospital server 3 giving approval to the first controller 1, an arrangement may be made wherein the domain names of the first controllers 1, working group names, or MAC addresses (unique addresses given to each network card), are used for giving approval.

It should be understood that the present invention is not intended to be limited to the embodiment described above; rather, various modifications may be made without departing from the essence of the invention. Also, other storage means such as a magneto-optical disk may be employed, for example, instead of the hard disk 52.

Moreover, an arrangement may be made wherein a third controller not shown in the drawing is installed in the conference room shown in FIG. 1, and the third controller integrates the endoscope images obtained from the first controller 1, the settings of the endoscope device, the setting information of the patient, and the patient information and the pre-surgery images obtained from the in-hospital server 3, into a single electronic file, which is transmitted to the surgery unit server 2.

It is clear that a wide variety of embodiments may be made based upon the present invention without departing from the spirit and scope of the invention. The present invention is not to be restricted by particular embodiments except as limited by the appended claims.

What is claimed is:

1. A medical information system comprising:
a server for registering patient identification information for identifying a patient, and accumulating personal information of the patient; and
a controller which is connected to a plurality of medical devices for surgery, for communicating with said server, and for creating clinical record information based upon medical information from said plurality of medical devices and said personal information from said server.

2. A medical information system according to claim 1, wherein said controller is connected to an input device for inputting said patient identification information and requiring personal information accumulated in said server based upon said patient identification information from the input device.

3. A medical information system according to claim 1, wherein said controller receives said personal information via a second server.

4. A medical information system according to claim 1, wherein said server is connected to said controller via a second server which reads out information accumulated in said server.

5. A medical information system, comprising:
a controller for collecting information from medical devices used in contact with a patient;
patient information accumulation means for accumulating patient identification information for identifying said patient; and
communication means for connecting said controller to said patient information accumulation means;
wherein said controller reads out at least one of said patient diagnosis information and said patient medical images from said patient information accumulation means, and stores the information obtained from said patient and said medical device in a correlated manner.

6. A medical information system according to claim 5, wherein said controller is provided with input means for inputting said patient identification information for identifying said patient.

7. A medical information system according to claim 6, wherein said controller reads out the related information from said patient information accumulation means based upon the patient identification information input from said input means.

8. A medical information system according to claim 6, wherein said input means is one of a magnetic-card reader, optical-card reader, IC card reader, and bar-code card reader.

9. A medical information system according to claim 6, wherein said input means is a keyboard.

10. A medical information system comprising:
a controller for collecting information from medical devices used in contact with a patient;
first patient information accumulation means for accumulating patient identification information for identifying said patient;
second patient information accumulation means which are connected to said controller via a first communication line, and is connected to said first patient information accumulation means via a second communication line;
wherein said second patient information accumulation means read out, from said first patient information accumulation means, at least one of
said patient identification information for identifying said patient,
diagnosis records for said patient, and
medical images of said patient,
and is capable of reading out this information from said controller.

11. A medical information system according to claim 10, wherein said controller reads out, from said first patient information accumulation means via said second patient information accumulation means, at least one of said patient identification information for identifying said patient, said diagnosis records for the patient, and said medical images of said patient, and stores the information and at least one of the information obtained from said patient and said medical device in said second patient information accumulation means in a correlated manner.

12. A medical information system according to claim 11, wherein said first patient information accumulation means reads out the information transmitted from said controller to said second patient information accumulation means.

13. A medical information system according to claim 11, wherein the information transmitted from said controller to said second patient information accumulation means is described in the XML format.

14. A medical information system comprising:
a server for registering patient identification information for identifying a patient, and for accumulating personal information of said patient;
a first controller which is connected to a plurality of medical devices for surgery, and which monitors the operation status of said plurality of medical devices, as well as controlling the devices; and
a second controller which communicates with said server, as well as being connected to said first controller, and creates clinical record information based upon said personal information from said server, and the information from said medical devices.

15. A medical information system for connecting a plurality of medical devices for surgery, said system comprising:
an in-hospital server for registering and accumulating personal information of a patient being subjected to surgery by said medical devices;
a controller having a communication interface circuit for receiving said personal information accumulated in said in-hospital server and a plurality of pieces of surgery information with regard to surgery from said medical devices;
a display device which is connected to said controller, for displaying said plurality of pieces of surgery information and said personal information received by said communication interface circuit;
a display information generating unit which is provided to said controller, for generating display position information with regard to said plural surgery information and said personal information for said display device; and
an information generating unit which is provided to said controller, for generating clinical record information based upon said display position information, said plural surgery information, and said personal information.

16. A medical information system for connecting a plurality of medical devices for surgery, said system comprising:
an in-hospital server for registering identification information for identifying a patient being subjected to surgery by said medical devices, as well as for accumulating first clinical record information made up of said pre-surgery medical information of said patient, which is correlated with said identification information;
a controller having a communication interface circuit for receiving said first clinical record information accumulated in said in-hospital server, and in-surgery medical information during surgery from said medical devices;
an input device which is connected to said controller, for inputting said identification information; and
a processor which is provided to said controller, for generating second clinical record information including said in-surgery medical information;
wherein said processor requires transmission of said first clinical record information corresponding to identification information input by said input device, and integrates said transmitted first clinical record information and said in-surgery medical information.

17. A medical information system for connecting a plurality of medical devices for surgery, said system comprising:
an in-hospital server for registering identification information for identifying a patient being subjected to surgery by said medical devices, as well as for accumulating first clinical record information made up of pre-surgery medical information of said patient, which is correlated with said identification information;
a controller having a communication interface circuit for receiving in-surgery medical information during surgery from said medical devices;
a surgery unit server for recognizing said controller as a client, as well as for communicating with said in-hospital server in a manner wherein said controller can access said first clinical record information accumulated in said in-hospital server;
an input device which is connected to said controller, for inputting said identification information; and
a processor which is provided to said controller, for generating second clinical record information including said in-surgery medical information;
wherein said processor requires transmission of said first clinical record information corresponding to said identification information input by said input device, and integrates said transmitted first clinical record information and said in-surgery medical information.

18. A medical information system for connecting a plurality of medical devices for surgery, said system comprising:
an in-hospital server for registering identification information for identifying a patient being subjected to surgery by said medical devices, as well as for accumulating first clinical record information made up of pre-surgery medical information of said patient correlated with said identification information;
a first controller having a communication interface circuit for receiving in-surgery medical information during surgery from said medical devices;
an input device which is connected to said first controller, for inputting said identification information;
a surgery unit server for recognizing said first controller as a terminal device, as well as for communicating with said in-hospital server in a manner wherein said first clinical record information accumulated in said in-hospital server is accessible; and
a second controller which is connected to said surgery unit server as a terminal device, for generating the second clinical record information including said in-surgery medical information;
wherein said second controller receives said identification information input by said input device and said in-surgery medical information from said first controller, requires transmission of said first clinical record information corresponding to the received identification information, and stores the transmitted first clinical record information and said in-surgery medical information.
